(19) United States
(12) Patent Application Publication
(10) Pub. No.: US 2014/0286361 A1
(43) Pub. Date: Sep. 25, 2014

(54) SYSTEMS AND METHODS OF CABLE MANAGEMENT

(71) Applicant: Clifford M. Risher-Kelly, Wells, ME (US)

(72) Inventor: Clifford M. Risher-Kelly, Wells, ME (US)

(73) Assignee: Draeger Medical Systems, Inc., Andover, MA (US)

(21) Appl. No.: 14/240,542

(22) PCT Filed: Sep. 9, 2011
(86) PCT No.: PCT/US2011/050952

§ 371 Date: May 9, 2014

(51) Int. Cl. H02B 1/20; H04L 29/08

(52) U.S. Cl. CPC H02B 1/202; H04L 67/12
USPC 370/537; 361/814

(57) ABSTRACT

A device for consolidating cables is provided, along with a method of consolidating Other embodiments are also described herein.

### FIELD OF THE INVENTION

The present invention relates generally to devices and methods for consolidating cables. More particularly, the present invention relates to the wireless consolidation of patient monitoring cables.

### BRIEF DESCRIPTION OF THE DRAWINGS

To facilitate further description of certain embodiments, the following drawings are provided. The same reference numerals in different figures denote the same elements.

FIG. 1 illustrates an example of a consolidation device according to an embodiment of the present invention.

FIG. 2 illustrates an example of a consolidation device coupled to a main unit with a cable according to an embodiment of the present invention.

FIG. 3 illustrates an example of a consolidation device coupled to a main unit according to an embodiment of the present invention.

FIG. 4 illustrates an example of a consolidation device coupled to a main unit wirelessly according to an embodiment of the present invention.

FIG. 5 illustrates another example of a consolidation device coupled to a main unit wirelessly according to an embodiment of the present invention.

FIG. 6 illustrates an example of a method of consolidating cables according to an embodiment of the present invention.

FIG. 7 illustrates an example of a data link system according to an embodiment of the present invention.

### DETAILED DESCRIPTION

Cable management is an important feature in patient monitoring equipment. Reducing the number of cables at a patient's bed makes it easier to care for the patient. Embodiments of the present invention include systems and methods for consolidating cables for patients. In some embodiments, such a system for consolidating cables comprises a consolidation device, which accepts connections from various patient monitoring connections. The consolidation device is then connectable to a main unit. In some further embodiments, the consolidation device is wirelessly connectable to the main unit. In yet more embodiments, the consolidation device captures patient data and passes that data to the main unit in real time.

Some embodiments include a consolidation device. The device may comprise: (a) one or more connectors configured to be coupled to a respective input cable; (b) a battery; (c) a wireless communication mechanism; and wherein the consolidation device is capable of passing data from each of the input cables to a main unit.

In another embodiment, a system for consolidating cables may comprise: (a) a main unit; and (b) a consolidation device comprising one or more connectors configured to be coupled with respective input cables; wherein the main unit and the consolidation device are coupled via a data link; and the consolidation device is configured to pass data obtained from the input cables to the main unit by way of the data link.

Other embodiments include a method of consolidating cables. The method may comprise: (a) providing a consolidation device; (b) providing a main unit; (c) coupling the consolidation device with main unit via a data link; (d) receiving one or more input data streams at the consolidation device; (e) consolidating the one or more data streams into a single data stream; (f) passing the single data stream from the consolidation device to the main unit via the data link; and (g) separating the single data stream into one or more output data streams corresponding to the one or more input data streams.

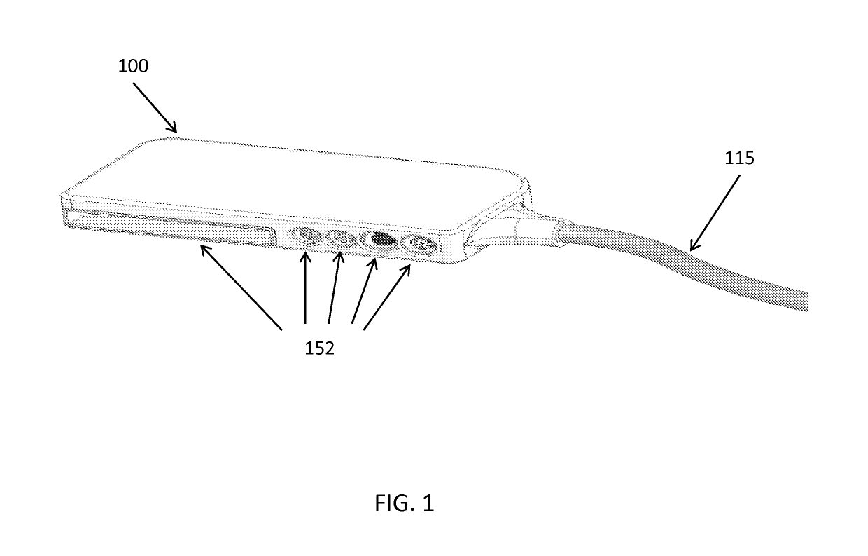

Turning to the drawings, FIG. 1 illustrates an example of consolidation device 100. Consolidation device 100 can be considered a device for consolidating cables. In the same or other embodiments consolidation device can be considered a device for consolidating cables for patient monitoring. In addition, in the same or other embodiments, consolidation device 100 can be considered a device for wirelessly consolidating cables for patient monitoring. Furthermore, consolidation device 100 can be considered a data concentrator that combines parameters from multiple data sources. Consolidation device 100 is exemplary and is not limited to the embodiments presented herein. Consolidation device 100 can be employed in different embodiments not depicted or described herein.

Consolidation device 100 can be a device that has one or more connectors configured to be coupled to at least one input cable with corresponding input signals. In certain embodiments, input signals can comprise patient monitoring signals, which may be related to a patient monitoring parameter that is to be monitored. Examples of patient monitoring parameters include, but are not limited to, electrocardiogram (EKG) signals, saturation of hemoglobin with oxygen as measured by pulse oximetry (SPO2), temperature (TEMP), end tidal carbon dioxide (ETCO2), hemodynamics (including blood pressures (invasive and non-invasive) and cardiac output), respiration gases (e.g., carbon dioxide (CO2), FiO2 (fraction of inspired oxygen), and anesthetic agents), blood gases (e.g., oxygen (O2) and CO2), patient temperature, and patient respiration.

Once consolidation device 100 receives any input signals at the one or more connectors, the signals can be passed to a separate unit, such as a main unit. In such embodiments, the main unit can comprise, as an example, a monitoring unit. In other examples, the main unit can comprise a printer, a central workstation, and the like.

In some embodiments, the input signals received by consolidation device 100 are passed to the main unit via a cable. In the same or other embodiments, the input signals received by consolidation device 100 are passed to the main unit via a wireless connection between consolidation device 100 and the main unit. In yet further embodiments, the input signals received by consolidation device 100 are passed to the main unit via a cable and/or a wireless connection between consolidation device 100 and the main unit. In the same or other embodiments, the main unit passes data signals to consolidation device 100.

With continued reference to FIG. 1, consolidation device 100 is configured to receive input signals from various input cables, such as, for example, patient monitoring cables. The patient monitoring cables connect to consolidation device 100 via one or more monitoring connections 152. In some embodiments, the monitoring connections 152 are able to be detachably connected to patient monitoring cables (not shown). In many examples, each particular one of the monitoring connections 152 is configured to receive a particular patient monitoring cable associated with a specific patient monitoring parameter. For example, a first one of the patient monitoring connections can be configured to receive a patient monitoring cable associated with EKG; a second one of the patient monitoring connections can be configured to receive a patient monitoring cable associated with SPO2 measurement; a third one of the patient monitoring connections can be configured to receive a patient monitoring cable associated with TEMP; a fourth one of the patient monitoring connections can be configured to receive a patient monitoring cable associated with ETCO2 measurement; and a fifth one of the patient monitoring connections can be configured to receive a patient monitoring cable associated with hemodynamics. It should be noted that consolidation device 100 can comprise more or less than 5 patient monitoring connections 152. Furthermore, consolidation device 100 can be configured so that patient monitoring connections 152 are configured to be connected to patient monitoring cables associated with parameters other than EKG, SPO2, Temp, ETCO2, and/or hemodynamics. Furthermore, consolidation device 100 can also be configured so that more than one of the patient monitoring connections 152 are configured to be connected to patient monitoring cables associated with the same type of patient monitoring parameters (e.g., two patient monitoring connections 152 can be associated with SPO2). Also, it is possible that one of the patient monitoring connections are configured to be connected to more than one type of patient monitoring cables.

It should be noted that patient monitoring connections 152 can be associated with other types of the patient monitoring cables not specifically mentioned above. For example, patient monitoring connections can be associated with invasive blood pressure (IBP). In addition, it is possible that patient monitoring connections 152 can be associated with monitoring pods as opposed to cables. In such an example, a pod receives multiple patient monitoring cables and thereby transmits the data obtained from those cables to consolidation device 100 via a cable coupled at one of the patient monitoring connections. Examples of pods can include, for example, hemodynamic pods, CNAP pods, and BIS Pods. Hemodynamic pods accept and combine multiple hemodynamic measurements. CNAP pods measure continuous non-invasive arterial pressure, and BIS pods measure bi-spectral index.

In some embodiments, consolidation device 100 has an analog front end for twelve lead EKG with respiration and ESU protection, two channel invasive blood pressure (IBP), SPO2, and two TEMP channels. In addition, it can also have 4 universal asynchronous receiver/transmitter (UART) channels. Furthermore, two of the channels may be dedicated to the ETCO2 connector and the other two channels may be used to replace the analog function of SPO2 or TEMP.

Table 1 lists an example of possible patient monitoring connections 152 according to an embodiment of consolidation device 100.

TABLE 1

| | | | | | | | | One wire |
|---|---|---|---|---|---|---|---|---|
| | Pins | Shields | Color | Power | UARTs | Analog Function | Extra | ID |
| EKG | 10 | 10 | Green | no | no | yes | ID pin | yes |
| ETCO2 | 7 | 1 | Yellow | 5 V | 2 | no | no | no |
| Hemo | 7 | 1 | Grey | 10 V | Pod com | yes | no | no |
| SPO2 | 7 | 1 | Blue | 5 V | 1 | yes | Masimo | |
| | | | | | | | connector | |
| Temp | 7 | 1 | White | 5 V | 1 | yes | | |
| | | | | | | | | One wire |
| | pins | shields | Color | power | UARTs | Analog Function | Extra | ID |
| EKG | 10 | 10 | Green | no | no | yes | ID pin | yes |
| ETCO2 | 7 | 1 | Yellow | 5 V | 2 | no | no | no |

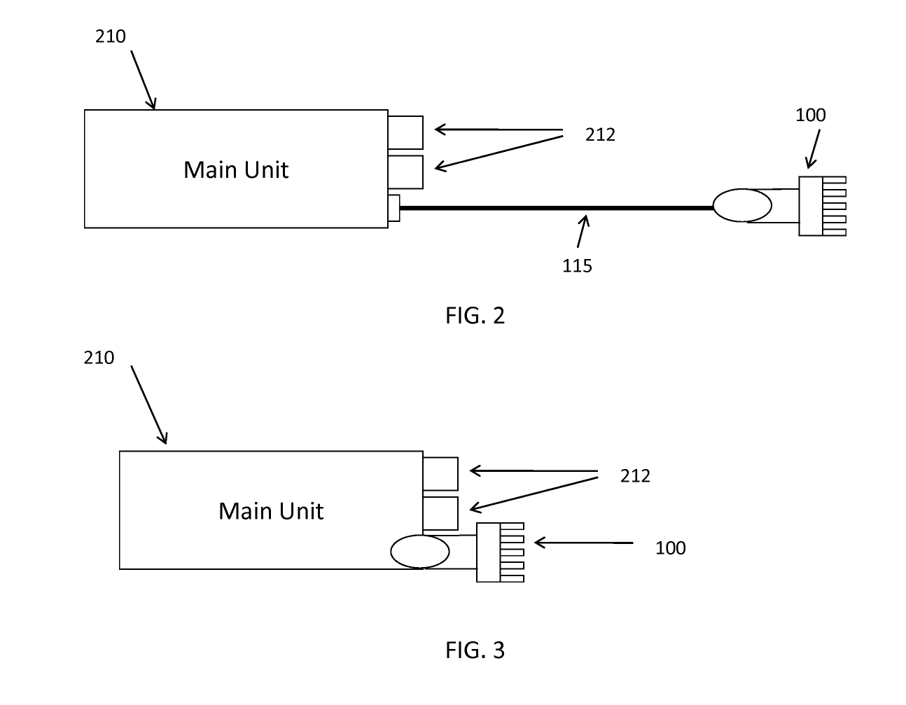

Consolidation device 100 can be configured to couple to a main unit 210 (as seen in FIG. 2). In some embodiments main unit 210 can comprise a patient monitor. In examples of such embodiments, the patient monitor can be capable of displaying the data (or processed data) obtained from at least one of the patient monitoring cables associated with the patient monitoring parameters. In other examples, the patient monitor is capable of displaying the data obtained from all of the patient monitoring cables associated with the patient monitoring parameters. Main unit 210 may also comprise a device other than a patient monitor. For example, a main unit can comprise a docking station, a printer, a central station (ADD OTHER POSSIBILITIES).

Consolidation device 100 is configured to be connectable to main unit 210. In some embodiments, consolidation device 100 is configured to be connected to main unit 210 via a cable 115. In the same or other embodiments, consolidation device 100 is configured to be connected to main unit 210 via a wireless connection. In the same or further embodiments, consolidation device 100 is configured to be connected to main unit 210 via cable 115 and/or the wireless connection.

FIG. 2 illustrates an example of an embodiment of consolidation device 100. In the example of FIG. 2, consolidation device 100 is coupled to main unit 210 via cable 115. Cable 115 can be used to provide power from main unit 210 to consolidation device 100. Furthermore, cable 115 can be used to transmit the data from the one or more patient monitoring cables via patient monitoring connections 152 on consolidation device 100. Cable 115 can comprise any type of cable commonly used. For example, cable 115 can comprise a USB cable. In other examples, cable 115 can be a proprietary based cable. In some embodiments consolidation device 100 can receive data signals from main unit 210. For example, consolidation device 100 can receive commands from main unit 210. An example of a command can comprise a command to change configurations of the analog front end.

In some embodiments, cable 115 can be removably attached to main unit 210 and removably attached to consolidation device 100. In other embodiments, cable 115 can be removably attached to either main unit 210 or consolidation device 100. In the above embodiments, it is possible that cable 115 can be stored in main unit 210 when cable 115 is not coupled to consolidation device 100. In other examples, cable 115 can be stored within consolidation device 100 when cable 115 is not attached to main unit 210.

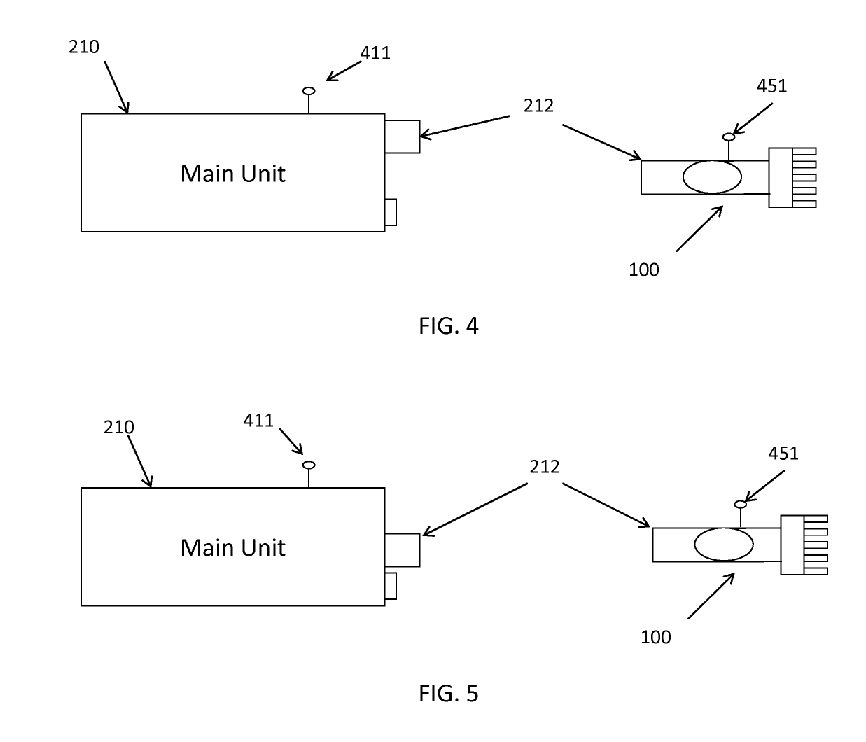

FIG. 4 illustrates an example of an embodiment of consolidation device 100, wherein cable 115 has been removed and consolidation device 100 is wirelessly coupled to main unit 210. In such an embodiment, consolidation device 100 can pass data concerning the patient monitoring parameters obtained from the patient monitoring cables via connectors 152 to main unit 110 without the use of a cable. The data can be passed between consolidation device 100 and main unit 210 via a wireless connection. The wireless connection between consolidation device 100 and main unit 210 can be accomplished using a wireless mechanism located in each consolidation device 100 and main unit 210. The wireless mechanisms can be configured to use any known method of wireless communication. For example, the wireless connection can be accomplished via Radio Frequency (RF) communication. In such embodiments, the wireless mechanisms comprise radios and, therefore, consolidation device 100 can include antenna 451 and main unit 210 can contain antenna 411. Antennas 411 and 451 are in communication with one another. In some examples, antennas 411 and/or 451 are located within the housing of consolidation device 100 and/or main unit 210. In the same or other examples, antennas 411 and/or 451 are located externally to the housing of consolidation device 100 and/or main unit 210. Examples of wireless communication can include, for example, Wireless Local Area Network (WLAN), e.g., 802.11a, 802.11b, 802.11g standard compatible communication; Wireless Patient Area Network (WPAN), e.g., 802.11a, 802.11b, 802.11g, 802.15x standard compatible communication; Wireless Wide Area Network (WWAN), e.g., GSM/GPRS standard compatible communication, Bluetooth communication, etc. In addition, other wireless communication methods can be used, such as, for example, Infrared Technology.

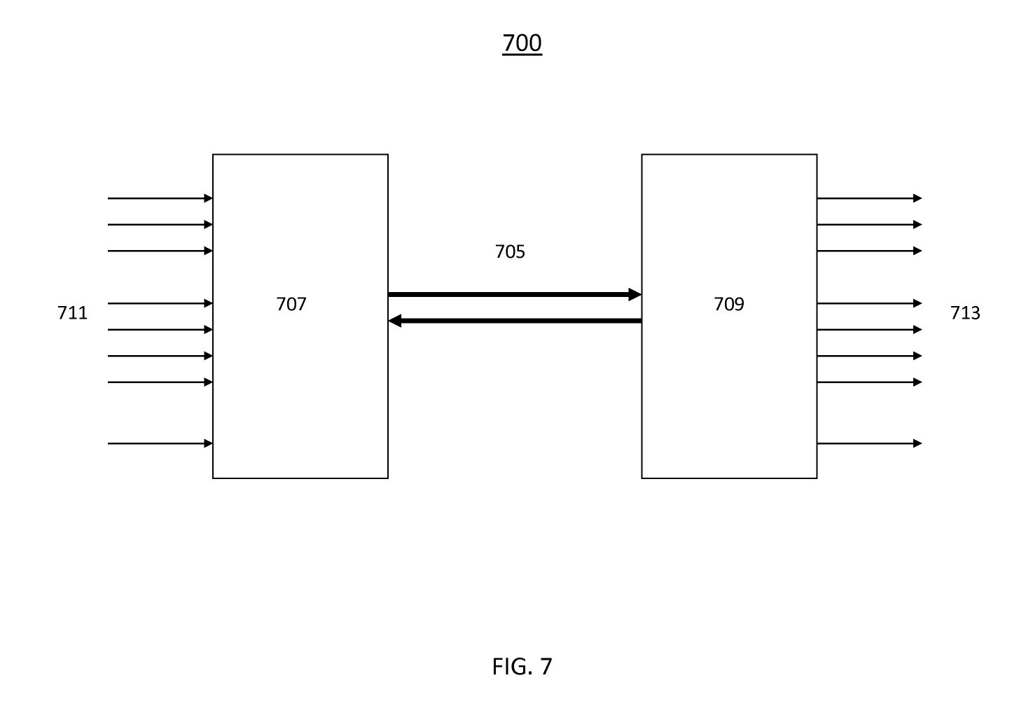

When consolidation device 100 and main unit 115 are communicating, wirelessly or through cable 115, the communication occurs through one or more data links. FIG. 7 illustrates an example of a data link system 700 between consolidation device 100 and main unit 210, according to an exemplary embodiment. In some embodiments, the dedicated data links between consolidation device 100 and main unit 115 are consolidated to a bidirectional data link. As seen in the example of FIG. 7, a data link 705 between consolidation device 100 and main unit 115 can be a bidirectional data link. The data concentrator 707, located within consolidation device 100, receives input streams 711 from the patient monitoring cables. Data concentrator 707 consolidates all of the input streams 711 received from the patient monitoring cables into a single stream. The data stream passes to data demultiplexer 709, located with main unit 210, via data link 705, which can be either be via cable 115 or the wireless connection. Data demultiplexer 709 separates the data from the single data stream into individual output data streams 713 corresponding to input streams 711, which can then used by main unit 210. In addition, if the data link is a bidirectional link, then consolidation device 100 can receive data signals from main unit 210.

In some embodiments it is necessary to encrypt the data passing through data link 705 for security reasons, especially when a wireless connection is used. In some examples, data concentrator 707 can also include encryption capabilities. Likewise, data demultiplexer 709 can include decryption capabilities. In such examples, data concentrator 707 and data demultiplexer 709 can comprise field programmable gate arrays (FPGAs). In other examples, an encryption unit and/or decryption unit can be supplied separate from data concentrator 707 and/or data demultiplexer 709.

Furthermore, in the same or other embodiments, further security may be supplied to data concentrator 707 and/or data demultiplexer 709. For example, data concentrator 707 and data demultiplexer 709 can be encapsulated with a substance, such as, for example, epoxy to ensure that the FPGAs are not tampered with. It should also be noted that the any radio units, which allow a wireless link to exist between consolidation device 100 and main unit 115, associated with data concentrator 707 and/or data demultiplexer 709 can also be encapsulated to ensure additional security.

Data link 705 can also comprise a real time link. As an example, it can be beneficial for the delay from consolidation device 100 to main unit 210 (or vice versa) to be a single data frame or 1 millisecond (msec). The 1 msec delay allows the system to provide a defibrillation synchronization output to a defibrillator and an analog output to a balloon pump from the main monitor. These outputs have a delay specification in the 30 msec range, which include delay introduced by filtering and other signal processing algorithm operations. In other examples, the delay can be greater than a single data frame or 1 msec. In some embodiments, if a single data frame is dropped between consolidation device 100 and main unit 210, the system will repeat the data from the previous data frame for periodic data.

As previously mentioned, in some embodiments data link 705 occurs via the wireless connection between consolidation device 100 and main unit 210. It is advantageous in such embodiments if the link between consolidation device 100 and main unit 210 has a range that is useable for its application, such as, for example, the monitoring of patients. In such examples, it may be desirable to a have a range of at least 3 meters. In other examples, it is desirable to have a range of at least 5 meters. In yet other examples, it is desirable to have a range greater than 5 meters. In addition, it may be desirable for the wireless connection to be able to operate with several other connections of the same type within close proximity of consolidation device 100 and main unit 210.

Also, when data link 705 occurs via the wireless connection, it may be important that data link 705 maintains a one to one association between consolidation device 100 and main unit 210. For example, once consolidation device 100 is associated with a particular main unit 210, it should stay associated with that particular main unit until it is powered down or until a user expressly discharges the main unit. Furthermore, in some embodiments, the one to one association between consolidation device 100 and main unit 210 can be maintained in an environment in which there are multiple main units and/or consolidation devices. For example, consolidation device 100 is associated with main unit 210 and a second main unit is associated with a second consolidation device, while the main unit 210, the second main unit, consolidation device 100, and the second consolidation device are all within range of each other's radio frequency transmissions. In other examples, more than two consolidation devices and/or main units can be present in a single environment.

The one to one association between a main unit and consolidation device can be accomplished a variety of ways. As one example, there can be a wired association. In such a setup, consolidation device 100 gets associated with main unit 210 while they are wired together. Thereafter, main unit 210 receives a radio signal from consolidation device 100, and then main unit 210 acknowledges that it is ready for wireless operation. When consolidation device 100 is unplugged from main unit 210, consolidation device 100 switches its signal to wireless (e.g., radio) almost instantaneously. For example, no more than 1 msec of data should be dropped during transfer from a wired link to a wireless link between consolidation device 100 and main unit 210. In other examples, more than 1 msec of data may be dropped. Similarly, when consolidation device 100 is plugged back into main unit 210, the signal switches from wireless to wired almost instantaneously again. In some embodiments, it may be desirable to require consolidation device 100 to make an association with main unit 210 via a wired connection.

In another example, there can be a bar code association. In such an example, main unit 210 is equipped with a camera that is capable of reading a bar code. The bar code is part of the outer case of consolidation device 100. Consolidation device 100 may be held in front of the camera of main unit 210 to recognize the bar code. When the code is recognized, a confirmation by the user allows consolidation device 100 to be associated to that main unit 210. This second model allows for easier transfer of consolidation device 100 between multiple main units if required.

As another example, a user would push a button (not shown) that would establish and confirm a wireless link between main unit 210 and consolidation device 100. In some examples, the button is located on main unit 210. In other examples, the button is located on consolidation device 100. Once the button is pushed, a wireless link between main unit 210 and consolidation device 100 will be established. In other embodiments, there may be a first button on main unit 210 and a second button on consolidation device 100. A user may have to push both buttons within a certain period of time to activate the wireless link. This may be helpful to avoid accidental wireless activation. In addition, this embodiment can enable consolidation device 100 to ensure that a specific link is created between a specific main unit and a specific consolidation device.

With reference to FIG. 2, consolidation device 100 can also comprise one or more batteries 212. Batteries 212 can be used to provide power to consolidation device 100. In some embodiments, batteries 212, when not providing power to consolidation device 100 can be stored via coupling to main unit 210, such as is shown in FIGS. 2-5. In such embodiments, main unit 210 can charge batteries 212 when batteries 212 are attached to main unit 210. In other embodiments, batteries 212 can be stored and/or charged with a device separate of main unit 210 when not being used to provide power to consolidation device 100.

In some embodiments, consolidation device 100 can use more than one battery to ensure a long lasting link with main unit 210. With reference to FIG. 4, one of the batteries (battery B) 212 is detached from main unit 210 and is coupled to consolidation device 100 to provide power to consolidation device 100. In embodiments using more than one battery 212, the one or more remaining batteries 212 may still be maintained within or coupled to main unit 210. If the battery (battery B) attached to consolidation device 100 runs low on power, it can be replaced by another of the batteries (e.g., battery A) 212. In some embodiments, consolidation device 100 can comprise an internal battery, thus allowing a period of time when consolidation device 100 can still be powered without being coupled with one of the batteries 212. For example, the internal battery can have 30 minutes of power, thus allowing consolidation device to be powered when consolidation device 100 is initially detached from cable 115, or when one battery 212 is being replaced by another battery 212. It should be noted that the 30 minute life of the internal battery is only an example, and the life of the internal battery may be greater than or less than 30 minutes.

In some embodiments, the units will alert a user that it is appropriate for the user to unplug cable 115 from consolidation device 100 and/or main unit 210. For example, main unit 210 may display a message that the data has switched to or established the wireless link and that it is safe to remove cable 115 from consolidation device 100. Such a message can be a message on the screen of main unit 210, a symbol, such as an icon, on the display of main unit 210, or any other indication that is noticeable to the user. In some examples, consolidation device 100 may contain a message indicating that it is acceptable for the user to remove cable 115. Furthermore, in other examples, instead of, or in addition to, a visual message, main unit 210 and/or consolidation device 100 may give an audio message (e.g., beep, spoken message, etc.) that it is acceptable to disconnect cable 260.

Subsequently, after a user has removed cable 115 from consolidation device 100 and/or main unit 210, one of the batteries 212 can be coupled to consolidation device 100, allowing the consolidation device to remain powered up. As previously indicated, consolidation device 100 may comprise an internal battery, thus allowing a period of time for the user to couple one of the batteries 212 to consolidation device 100. With such an internal battery, a user will have sufficient time to remove cable 115 and to couple one of the batteries 212 to consolidation device 100. As another example, because of the internal battery, a user can replace one depleted battery 212 or nearly depleted battery 212 with another battery 212 that has a charge.

In some embodiments of the present invention, consolidation device 100 can give a warning signal that the battery 212 that is attached to consolidation device 100 is about to lose power. Such a warning signal can be visual, auditory, or both. Such a warning signal would allow the user ample time to remove the battery 212 attached to consolidation device 100 and to attach a second battery 212 to consolidation device 100. The first battery, whose power is now drained, can be coupled to main unit 210 to be recharged. FIG. 5 illustrates an example of when one battery 212 (battery B) has been replaced with another battery 212 (battery A). As can be seen, FIG. 4 illustrates an example where a first one of the batteries 212 (battery B) is coupled with consolidation device 100 and a second one of the batteries 212 (battery A) is coupled to main unit 210. FIG. 5 then shows the example where a user has switched the batteries so that the second one of the batteries 212 (battery A) is now coupled with consolidation device 100 and the first one of the batteries 212 (battery B) is now coupled to main unit 210.

FIG. 3 depicts an example of another embodiment of the present invention. When consolidation device 100 is not in use, it can be stored within main unit 210. In such an example, consolidation device 100 is physically coupled to main unit 210 and batteries 212 are coupled to main unit 210. In addition, main unit 210 is capable of charging batteries 212.

In addition, FIG. 3 can depict an example of the use of consolidation device 100 when main unit 210 is located close to a patient. Therefore a cable, such as, for example cable 115 or a wireless connection is not necessary to link consolidation device 100 and main unit 210. In such an example, the physical coupling of consolidation device 100 and main unit 210 is also an electrical coupling in which data link 705 is established via that coupling.

In some embodiments, consolidation device 100 can include buttons that enable the consolidation device to perform various procedures. As examples, consolidation device 100 may have buttons that perform one or more of the following procedures: zeroing of transducers, starting the measurement of cardiac output, starting and/or stopping the measurement of non-invasive blood pressure (NIBP), and silencing alarms.

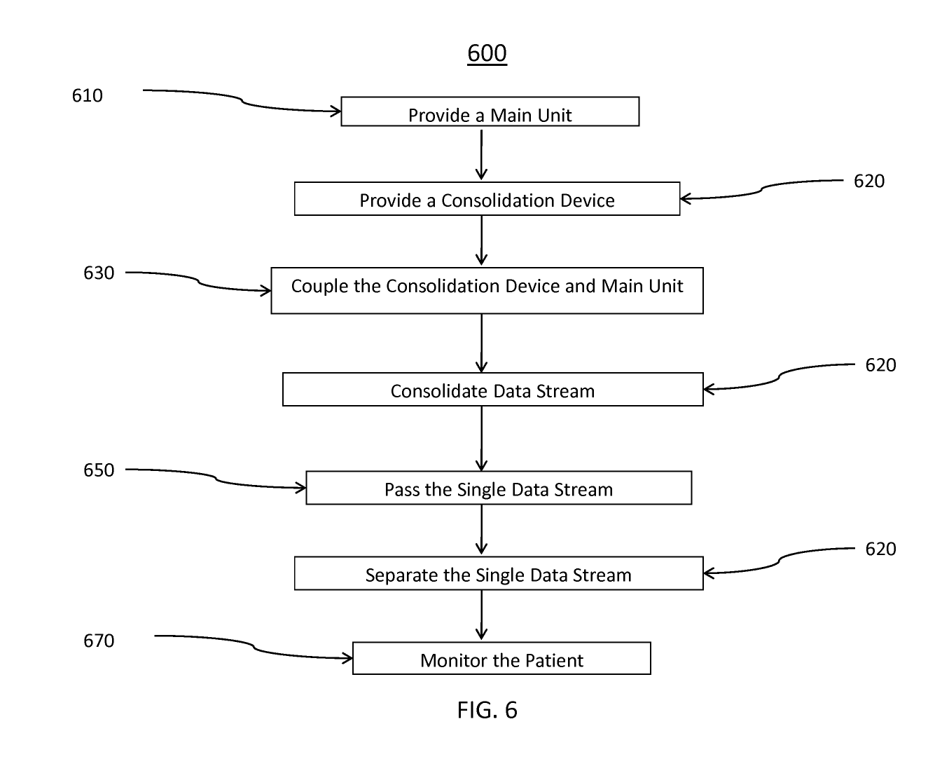

FIG. 6 illustrates an example of a method 600 of consolidating cables according to another embodiment. In some embodiments, method 600 can be considered a method of consolidating patient monitoring cables. In yet other or the same embodiments, method 600 can be considered a method of wirelessly consolidating patient monitoring cables. Method 600 is exemplary and is not limited to the embodiments presented herein. Method 600 can be employed in different embodiments not depicted or described herein.

Method 600 comprises a procedure 610 of providing a main unit. In some embodiments, the main unit can comprise a monitor. In the same or other embodiments, the main unit can be the same as or similar to main unit 210 (FIGS. 2-5) described above.

Method 600 also comprises a procedure 620 of providing a consolidation device. In some embodiments, the consolidation device can comprise a device for receiving patient monitoring cables. In the same or other embodiments, the consolidation device can be the same as or similar to consolidation device 100 (FIGS. 1-5) described above.

In addition, method 600 also comprises a procedure 630 of coupling the main unit and the consolidation device. In some embodiments, the main unit and the consolidation device can be coupled via a data link. The data link can be the same as or similar to data link 705 (FIG. 7) from above. In some examples, the data link can be a wired link, such a for example when a cable is used. The cable can be the same as or similar to cable 115 (FIG. 1) from above. In yet other examples, the data link can be a wireless link, which can be the same as or similar to the wireless connection from above.

As demonstrated above, there are a multitude of procedures to couple the main unit to the consolidation device. Examples from above include coupling the main unit and consolidation device via a cable, such as cable 115; using a camera on the main unit to read a bar code located on the consolidation device; and pushing buttons located on the main unit and/or consolidation device.

Method 600 further can comprise a procedure 640 of consolidating each of the data streams obtained from the patient monitoring cables into a single data stream. In many examples this can be accomplished using a data concentrator, which can be located with the consolidation unit. The data concentrator can be the same as or similar to data concentrator 707 (FIG. 7) above.

Method 600 also includes a procedure 650 of passing the single data stream from the consolidation device to the main unit. In some examples, the single data stream is passed via the data link. The data link can be the same as or similar to data link 705 (FIG. 7) from above. If the data link comprises a wireless link, the consolidation device can transfer data packets comprising the single data stream with information from the patient monitoring cables to the main unit wirelessly, as opposed to using a cable.

Method 600 further can comprise a procedure 660 of separating the single data stream into output data streams corresponding to each of the data streams obtained from the patient monitoring cables. In many examples this can be accomplished using a data demultiplexer, which can be located with the main unit. The data demultiplexer can be the same as or similar to data demultiplexer 709 (FIG. 7) above.

Furthermore, method 600 also includes a procedure 670 of monitoring the patient. Procedure 670 can comprise using the output data streams for monitoring purposes. For example, the main unit can then display the data obtained, record the data, pass the data on to another source, combinations thereof, or the like.

It should be noted that procedures 610 through 670 are numbered for convenience, and don't necessarily indicate that they must occur in any particular order. For example, procedure 620 can occur before procedure 610.

It should also be noted that some of the procedures may be skipped. For example, in some embodiments, it may be useful to not include procedure 640 if there is no desire or need for the input data streams to be consolidated into a single data stream.

Furthermore, it should also be noted that after procedure 670, other procedures may follow. For example, it may be desirable to once again couple the consolidation device with a new main unit. As such, the consolidation device and the main unit would be decoupled and procedure 610 would once again be used, followed by procedure 630, since a new consolidation device would not be needed.

In addition, further procedures not described herein can be added to method 600. For example, a procedure of sounding an alarm if a battery gets low could be added. As another example, it may be necessary to encrypt the single data stream for added security, especially when a wireless link is being used. As such there would be a procedure of encrypting the single data stream and another procedure for decrypting the single data stream. The embodiments listed above are only exemplary and may be altered or changed within the spirit of the invention.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the semiconductor device and its methods of providing the semiconductor device discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A consolidation device, comprising:
one or more connectors configured to be coupled to a respective input cable;
a battery;
a wireless communication mechanism; and
wherein the consolidation device is capable of passing data from each of the input cables to a main unit.

2. The device of claim 1, wherein:
each of the respective input cables comprises a patient monitoring cable.

3. The device of claim 2, wherein:
at least one of the patient monitoring cables comprises an EKG cable, a TEMP cable, an SPO2 cable, an ETCO2 cable, or a hemodynamics cable.

4. The device of claim 3, wherein:
a first one of the connectors is configured to be coupled with an EKG cable;
a second one of the connectors is configured to be coupled with a TEMP cable;
a third one of the connectors is configured to be coupled with a SPO2 cable;
a fourth one of the connectors is configured to be coupled with a hemodynamics cable.

5. The device of claim 1, further comprising:
a cable for coupling the consolidation device to the main unit.

6. The device of claim 5, wherein:
the cable for coupling the consolidation device to the main unit is capable of establishing the wireless communication mechanism.

7. The device of claim 1, wherein;
one of the consolidation device or main unit comprises a button that establishes the wireless communication mechanism.

8. The device of claim 1, wherein:
the wireless mechanism comprises a radio device configured to communicate with a second radio device on a main unit; and
the wireless mechanism is configured to pass the data obtained from each of the input cables to the main unit wirelessly.

9. A system for consolidating cables, comprising:
a main unit; and
a consolidation device comprising one or more connectors configured to be coupled with respective input cables;
wherein:
the main unit and the consolidation device are coupled via a data link; and
the consolidation device is configured to pass data obtained from the input cables to the main unit by way of the data link.

10. The system of claim 9, wherein:
the main unit is configured to pass data from the main unit to the consolidation device.

11. The system of claim 10, wherein:
each of the one or more input cables comprises an input data stream;
the consolidation device comprises a data concentrator configured to consolidate the one or more input data streams into a single data stream;
the main unit comprises a data demultiplexer configured to separate the single data stream into one or more output data streams corresponding to a respective input data stream; and
the single data stream passes from the consolidation device to the main unit via the data link.

12. The system of claim 11, wherein:
the consolidation device comprises an encryption unit configured to encrypt the single data stream; and
the main unit comprises a decryption unit configured to decrypt the encrypted single data stream.

13. The system of claim 12, wherein:
the data concentrator comprises the encryption unit and the data demultiplexer comprises the decryption unit.

14. The system of claim 10, wherein:
each of the respective input cables comprises a patient monitoring cable.

15. The system of claim 10, wherein:
the data link is a wired link.

16. The system of claim 10, wherein:
the data link is a wireless link.

17. The system of claim 16, wherein:
the main unit comprises a symbol to indicate that the data link is a wireless link.

18. The system of claim 16, wherein:
the main unit comprises a reader;
the consolidation device comprises a bar code; and
the reader is configured to scan the bar code, thereby establishing an association between the main unit and consolidation device.

19. The system of claim 16; further comprising:
one or more batteries configured to provide power to the consolidation device when the one or more batteries are coupled to the consolidation device.

20. The system of claim 19, wherein:
the main unit is configured to charge the one or more batteries when the one or more batteries are coupled to the main unit.

21. The system of claim 16, wherein:
the wireless data link is capable of being maintained within proximity of one or more additional wireless data links.

22. The system of claim 10, wherein:
the data link is a real time data link.

23. The system of claim 22, wherein:
a delay in the data link should be less than one millisecond.

24. A method for consolidating cables, comprising:
providing a consolidation device;
providing a main unit;
coupling the consolidation device with main unit via a data link;
receiving one or more input data streams at the consolidation device;
consolidating the one or more data streams into a single data stream;
passing the single data stream from the consolidation device to the main unit via the data link; and
separating the single data stream into one or more output data streams corresponding to the one or more input data streams.

25. The method of claim 24, wherein:
coupling the consolidation device with the main unit via a data link comprises establishing a wireless connection between the main unit and the consolidation device.

26. The system of claim 9, wherein one of the main unit or the consolidation unit are configured to display a message indicating that a wireless link has been established.

27. The system of claim 9, wherein one of the main unit or the consolidation unit are configured to provide an audio indication that a wireless link has been established.
